(19) United States
(12) Patent Application Publication
(10) Pub. No.: US 2019/0359341 A1
(43) Pub. Date: Nov. 28, 2019

(54) METHOD OF THERMAL ICE PROTECTION FOR AN AIRCRAFT WING

(71) Applicant: The Boeing Company, Chicago, IL (US)

(72) Inventors: Charles S. Meis, Renton, WA (US); Kuohsing E. Hung, Woodinville, WA (US)

(73) Assignee: The Boeing Company, Chicago, IL (US)

(21) Appl. No.: 15/989,494

(22) Filed: May 25, 2018

(51) Int. Cl. B64D 15/04; B64D 15/20

(52) U.S. Cl. CPC B64D 15/04; B64C 9/22; B64D 15/20

(57) ABSTRACT

A thermal ice protection system including a spray tube for spraying engine bleed air on an interior surface of an aircraft wing leading edge. The engine bleed air impinges simultaneously at multiple locations on the interior surface heats the aircraft leading edge so as to inhibit the formation of ice on the aircraft leading edge at the predetermined ice susceptible areas. The spray tube is particularly intended to be used to heat a wing slat leading edge skin/surface without using a nose beam or other internal structure to direct the flow of the engine bleed air.

### BACKGROUND

### 1. Field

The present disclosure describes a novel ice protection system for an aircraft.

### 2. Description of the Related Art

FIG. 1 illustrates a typical aircraft (100) having swept wings (102) and engines (104), and FIG. 2 shows the typical forces (weight, lift, drag, and thrust) applied to the aircraft wings (102). The aircraft (100) is typically designed so that the lift on the wing (102) can be optimized using a leading edge moveable or fixed slat device (200) at the front of the main (or fixed) wing (102).

Federal Aviation Administration (FAA) regulations define atmospheric envelopes in which icing conditions must be considered for aircraft design and certification because the accumulation of ice on the critical surfaces (e.g. leading edge) of aircraft wings can present a threat to the safe flight of an aircraft. Given that even a small amount of ice accumulation on the leading edge of the aircraft wing can have significant impacts on lift and drag characteristics, the need exists for a means of anti/de-icing the wing leading edge surfaces. Since the lift force of the wing is mainly generated on the upper surface of the wing, it is of the utmost importance that the upper surface of the wing be free of inflight ice accretion; therefore, a thermal anti/de-ice system should be optimized to protect the upper surface of the fixed wing and/or leading edge slat.

FIG. 3A is a cross-sectional view of a wing leading edge slat (300) along section A-A in FIG. 1, illustrating a conventional thermal anti/de-ice system (300b) using heated air from engine bleed. The system includes a tube 302 (commonly referred to as a piccolo tube because it may resemble a straight tube with multiple holes to discharge air), and a structural member that aids in structurally supporting the wing leading edge as well other thermal heating aspects of the system (see also U.S. Pat. No. 5,011,098). The tube (302) is attached to the structural member (e.g., nose beam 306) using a bracket (304), as illustrated in FIG. 3B.

FIG. 3A further illustrates how the structural member (a nose beam (306) or a channel or a double wall) re-directs or guides the flow of air from the tube (302) in a direction (308) towards the upper surface (310) of the slat (300) to predetermined locations (330) for melting ice (332), and then eventually in a direction (312) out an exhaust hole (314) at the bottom of the slat (300). The exhaust hole (314) aids in distribution of the air above and around the nose beam (306). Also shown in FIG. 3 is the forwardmost point or highlight (316) on the wing (102) which typically also requires de-icing during flight.

In some cases, however, the structure of the wing leading edge may not lend itself to the traditional means of thermal anti/de-icing illustrated in FIG. 3. What is needed then, are new and unique means of providing thermal ice protection to a wing leading edge surface that do not require a wall structure to direct the hot air used for de-icing. The present disclosure satisfies this need.

### SUMMARY

The present disclosure describes a thermal ice protection system attached to an aircraft wing and including a spray tube positioned in relation to an interior surface of a leading edge slat of the wing. The thermal ice protection system is connected to an engine on the aircraft so as to transfer hot air from the engine into the spray tube. The spray tube includes a plurality of spray holes through which the hot air can be sprayed and the spray holes are disposed such that the hot air can be directly is sprayed to a plurality of predetermined locations on the interior surface of the leading edge slat. The interior surface is thermally coupled to an external surface on the wing where ice may form during flight. At least a portion of the heat transported by the hot air is transferred to the external surface and melts or inhibits formation of ice on the external surface.

Examples of the thermal ice protection system include, but are not limited to, any combination of the following examples.

1. The thermal ice protection system attached to the wing including a fixed, aft end spaced apart from the leading edge slat, wherein the spray tube is disposed between the leading edge slat and the fixed, aft end and a plurality of supports are disposed in a spaced relationship along a wing leading edge of the wing. The spray tube is disposed or attached on the supports such that the hot air can be sprayed through the spray holes at the predetermined locations.

2. The thermal ice protection system of embodiment 1, wherein the supports are connected/attached to the leading edge slat and attach the spray tube to the leading edge slat.

3. The thermal ice protection system wherein the spray tube is attached to the leading edge slat.

4. The thermal ice protection system wherein the plurality of spray holes are disposed in a plurality of rows on the spray tube.

5. The thermal ice protection system wherein the spray holes are located and oriented so as to direct the hot air in a direction (e.g., +/−90 degrees from a horizontal direction) that covers area from a small portion of the lower surface to majority of the upper surface of the wing.

6. The thermal ice protection system wherein the spray holes are disposed 360 degrees about a circumference of the spray tube.

9. The thermal ice protection system wherein the spray holes have a diameter in a range of 1/20 inch to ⅕ inch and are spaced apart by a distance in a range of 0.5 inches to 5 inches.

10. The thermal ice protection system wherein the spray tube has a diameter in a range of 1 inch to 10 inches.

11. The thermal ice protection system wherein the spray tube has a length in a range of 5 feet to 80 feet.

12. The thermal ice protection system wherein the spray tube comprises a composite material or metal (e.g., aluminum or titanium).

13. The thermal ice protection system further comprising open space between the spray holes and the predetermined locations.

14. The thermal ice protection system wherein the wing does not include a wall or other structural member that guides engine bleed air from the spray tube to pre-determined locations for melting ice.

15. The thermal ice protection system further comprising a processor coupled to the thermal ice protection system, wherein the processor controls flow of the hot air into the spray tube without accounting for air movement along a channel or other internal structure.

17. The thermal ice protection system attached to a wing having a wing span in a range of 40-200 feet.

18. The thermal ice protection system attached to a wing having a maximum thickness (T) in a range of 1-5 feet.

19. The thermal ice protection system attached to a wing whose upper surface and lower surface have tangents at an angle of less than 30 degrees when the tangent to the upper surface and the tangent to the lower surface of the wing are at points directly above and directly below the spray tube, respectively.

20. The thermal ice protection system wherein the wing does not include a nose beam and comprises a chordwise structural member increasing stiffness of the wing.

The present disclosure further describes a method of operating a turbofan engine, comprising operating a thermal ice protection system connected to the turbofan engine and comprising a spray tube capable of spraying engine bleed air, received from the turbofan engine, directly onto an interior surface of the aircraft's wing (e.g., as illustrated by any of the embodiments described herein). The thermal ice protection system directly spraying the engine bleed air onto the interior surface reduces or prevents ice build up on the wing external surface more effectively, and thereby also reduces aerodynamic drag of the wing and fuel consumption, as compared to the ice protection system including a spray tube that does not directly spray engine bleed air onto the interior surface.

### BRIEF DESCRIPTION OF THE DRAWINGS

FIG. 1. Diagram of a large aircraft, wherein cross-section A-A indicates an area on the wing where wing ice protection is typically required and/or provided.

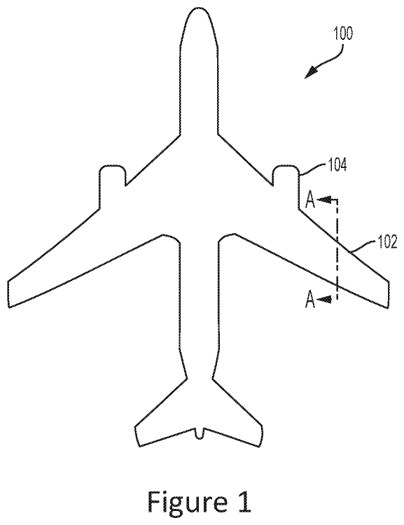

FIG. 2. Cross-sectional diagram along A-A in FIG. 1 showing inflight or aerodynamic forces on the wing, namely lift, weight, thrust and drag.

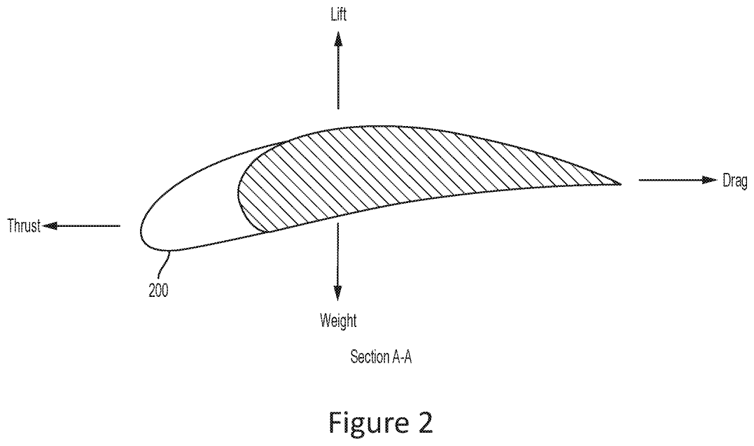

FIG. 3A. Cross-section of a wing showing typical structural provisions of conventional thermal ice protections systems.

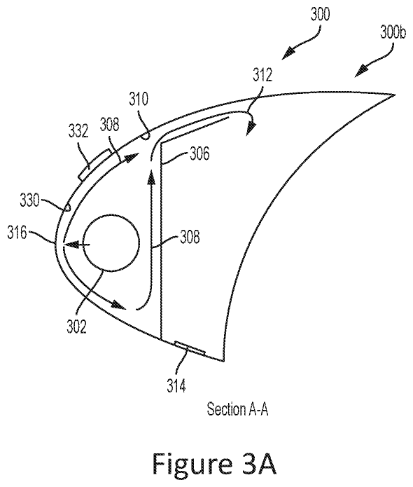

FIG. 3B. Cross-section of a wing showing attachment of tubes to structural members using brackets in a conventional thermal ice protections system.

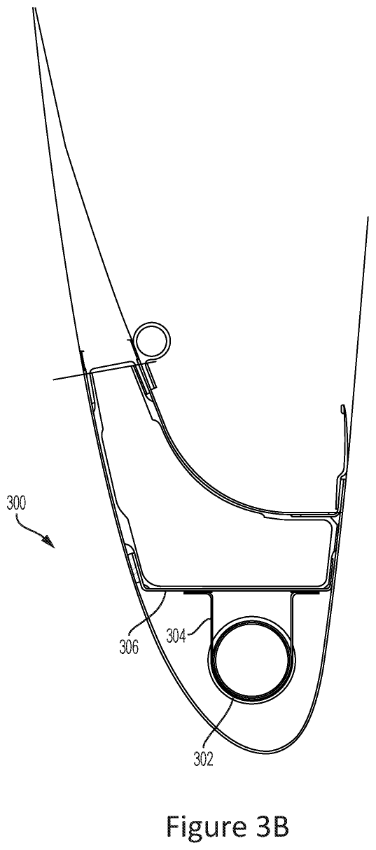

FIG. 4. Schematic diagram showing a wing ice protection system (e.g., anti or de-ice system) architecture, according to one or more embodiments of the present invention.

FIG. 5A. Cross-section of a wing showing the ice protection system according to one example wherein the spray tube includes multiple rows of spray holes directing hot air to an interior surface of a wing leading edge.

FIG. 5B. Schematic illustration of a leading edge slat showing the spray tube is attached to the leading edge slat using ribs.

FIG. 5C. Cross-section of a wing showing how an exemplary ice protection system can be implemented in wings that are narrow or thin.

FIG. 5D. Schematic showing the ice protection system according to one example installed on an aircraft.

FIG. 6. Flowchart illustrating a methodology for designing and optimizing the spray tube design.

FIG. 7. Flowchart illustrating a method of assembling a thermal ice protection system.

FIG. 8. Diagram showing normal inflight operation of the wing ice protection system described herein.

FIG. 9. Flowchart illustrating method of operating a turbofan engine with reduced fuel consumption.

FIG. 10. Processing environment for operating the thermal ice protection system described herein.

### DESCRIPTION

In the following description, reference is made to the accompanying drawings which form a part hereof, and which is shown, by way of illustration, several embodiments. It is understood that other embodiments may be utilized and structural changes may be made without departing from the scope of the present disclosure.

### Technical Description

### Example Structure

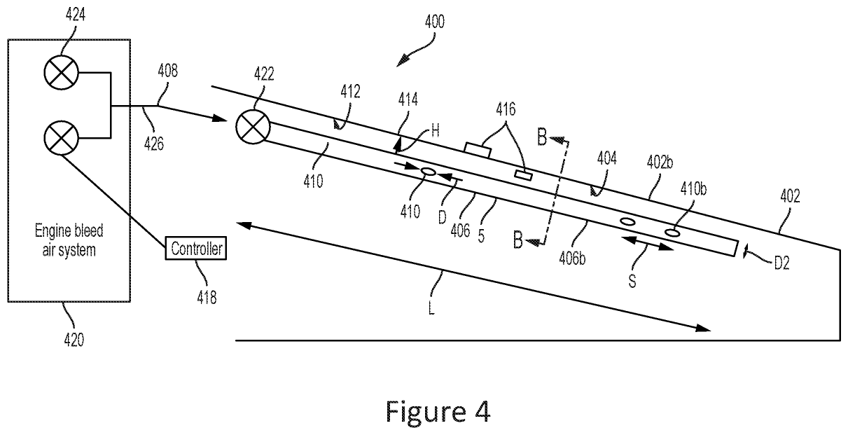

FIG. 4 illustrates pertinent elements of an aircraft thermal ice protection system (400) (e.g., anti-ice or de-ice system) for a wing (402) including a wing leading edge (402b) having an interior surface (404). The thermal ice protection system (400) is attached to the wing (402), comprises a spray tube (406), and is connected to an engine (104, 546) on an aircraft (100, 532) so as to transfer hot air (408) from the engine (104, 546) into the spray tube (406).

The spray tube (406) includes a plurality of spray holes (410) through which the hot air (408) is sprayable. As illustrated in FIG. 4, the spray tube (406) is positioned in relation to the interior surface (404) and the spray holes (410) are disposed in the spray tube (406) such that the hot air (408) is directly sprayable to a plurality of predetermined locations (412) on the interior surface (404). In the example of FIG. 4, the spray tube (406) is routed down the wing leading edge (402b) of the wing (402). Heat (H) is transported by the hot air (408) sprayed from the spray holes (410) to the interior surface (404) which is thermally coupled to an external surface (414) on the wing (402) where ice (416) may form during flight, so that at least a portion of the heat (H) is transferred to the external surface (414) and melts or inhibits formation of the ice (416).

The spray holes (410) may have a variety of diameters (D) and spacing (S). For example, the spray holes (410) may have a diameter (D) in a range of 1/20 inch to ⅕ inch and/or may be spaced apart by a distance (S) in a range of 0.5 inches to 5 inches.

The spray tube (406) may have a variety of lengths (L) and diameters (D2). For example, the spray tube (406) may have a diameter (D2) in a range of 1 inch to 10 inches and/or a length (L) in a range of 5 feet to 80 feet.

In order to control the flow of the hot air (408), the thermal ice protection system (400) comprises, or is coupled to, a controller (418) or processor (418b), an engine bleed air source (e.g., the aircraft engine (104)) and an engine bleed air system (420) including a valve (422) or system of valves (424) allowing the hot air (408) (e.g., engine bleed air (426)) to enter the spray tube (406).

The ice protection system may further include additional features that are known to those skilled in the art, such as pressure sensors, wiring, and additional structural members of the wing.

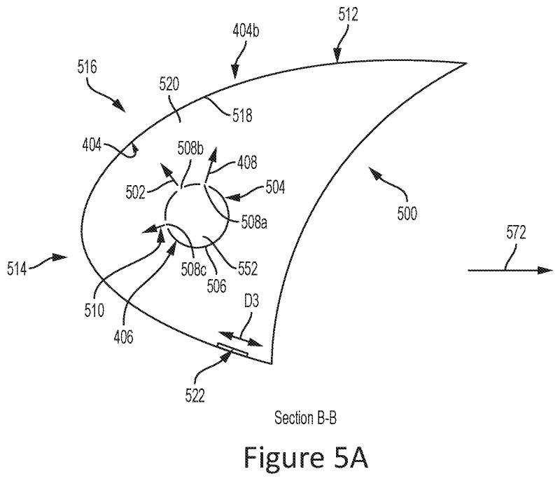

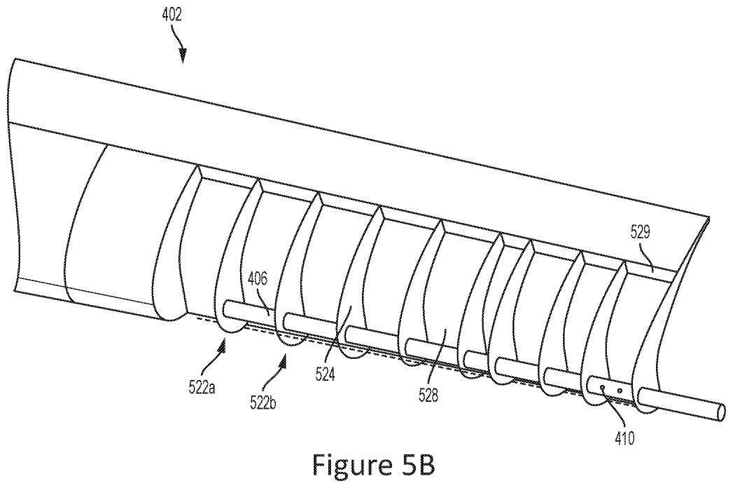

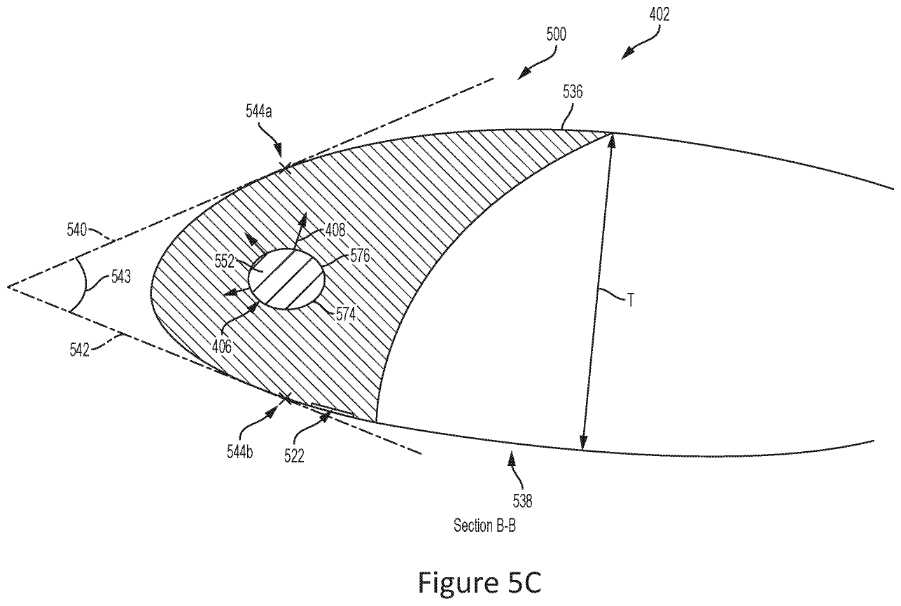

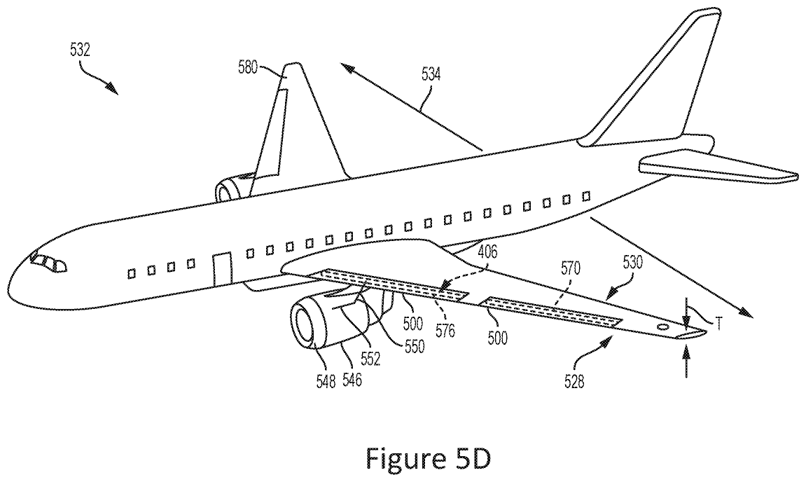

FIG. 5A is a cross section along B-B′ in FIG. 4 showing the new and unique features of a thermal ice protection system (400) including the positioning of the spray holes (410) on the spray tube (406) in relation to the interior surface (404) of the leading edge slat (500). FIG. 5A illustrates there is no structural member (304) required to direct the flow of the hot air (408) towards the upper surface (404b) of the leading edge slat (500).

Optimization is achieved by placement of the spray holes (410), the amount of the hot air (408) sprayed in various directions (502) from the spray tube (406), and/or the size (e.g., diameter D) of the spray holes (410) at the different locations (504) on the spray tube (406). In one or more examples, the spray tube (406) (e.g., piccolo spray tube 506) comprises multiple rows (508a, 508b,508c) of spray holes (410), the location (504) and orientation (510) of which are optimized to direct the hot air (408) from the spray tube (406) towards the internal wing leading edge structural location (512) where ice (416) may form during flight. As shown illustratively in FIG. 5A, there may be a row (508c) of holes pointing towards the forwardmost point (514) of the airfoil (516), typically called the highlight (316). In addition, or alternatively, there may be another one or more rows (508b) of spray holes (410) pointing upwards at critical locations (518) on the upper surface (404b) of the wing (402). Since there is no nose beam (306), the spray tube (406) as illustrated in FIG. 5A has the flexibility of pointing the flow of hot air (408) directly at these critical locations (518) without the need to account for air movement along a channel, nose beam (306), or other internal structure (i.e., there is open space (520) between the spray holes (410) and the predetermined locations (412) on which the hot air (408) is impinging from the spray holes (410).

In one or more examples, the wing (402) includes an exhaust hole (522) having a diameter (D3) that may be smaller than the exhaust hole (314) in a thermal ice protection system (300b) having a structural member (e.g., nose beam (306)) guiding the hot air to the predetermined locations for de-icing.

FIG. 5B illustrate an example wherein the thermal ice protection system (400) further includes one or more supports (522a, 522b) (e.g., ribs (524)) attached/connected to the leading edge slat (500) and disposed in a spaced relationship along the wing leading edge (402b). The supports (522a, 522b) attach the spray tube (406) to the leading edge slat (500) such that the hot air (408) can be sprayed through the spray holes (410) at locations (526) between adjacent supports (522a, 522b). Although ribs (524) are illustrated in FIG. 5B, other supports can be used including, but not limited to, brackets. In the example of FIG. 5B, the leading edge slat (500) further includes a cove skin (528) (e.g., 0.1 inch thick aluminum), a J-spar (529) (e.g., 0.1 inch thick aluminum). FIG. 5B further illustrates an example wherein the spray holes 410 have a diameter D of 0.141 inches and are spaced with a spacing of 1.8 inches.

FIG. 5C illustrates the thermal ice protection system (400) can be implemented in wings (402) that are narrow or thin, e.g., wings (402) whose upper surface (536) and lower surface (538) have tangents (540, 542) at an angle (543) of less than 30 degrees (wherein the tangent (540) to the upper surface (536) and the tangent (542) to the lower surface (538) of the wing are at points (544a, 544b) directly above and directly below the spray tube (406), respectively).

FIG. 5D illustrates the thermal ice protection system (400) may be incorporated in a variety of aircraft (532) having a variety of wing spans (534) and maximum thicknesses (T) of the wing (402). For example, the thermal ice protection system (400) can be mounted or attached to aircraft (532) having a wing span (534) in a range of 40-200 feet (e.g., 80 feet-120 feet, 40-120 feet, or 180 feet-200 feet) and/or aircraft (532) having a wing (402) including a maximum thickness (T) in a range of 1-5 feet. The thermal ice protection system (400) or spray tube (406) is disposed between the leading edge slat (500) and the fixed, aft end (530) of the wing (402).

FIG. 5D further illustrates the aircraft includes one or more engines (546) (e.g., turbofan engines (548)) connected to the thermal ice protection system (400) using a system of conduits (550) or ducts transporting engine bleed air (552) comprising the hot air (408) from the engine (546) to the spray tube (406). In one or more embodiments, the engines (546) are configured for use with the thermal ice protection system (400). For example, the engines (546) may be re-sized (have reduced thrust) or operated with reduced fuel consumption.

Process Steps

a. Optimization of Spray Tube Design

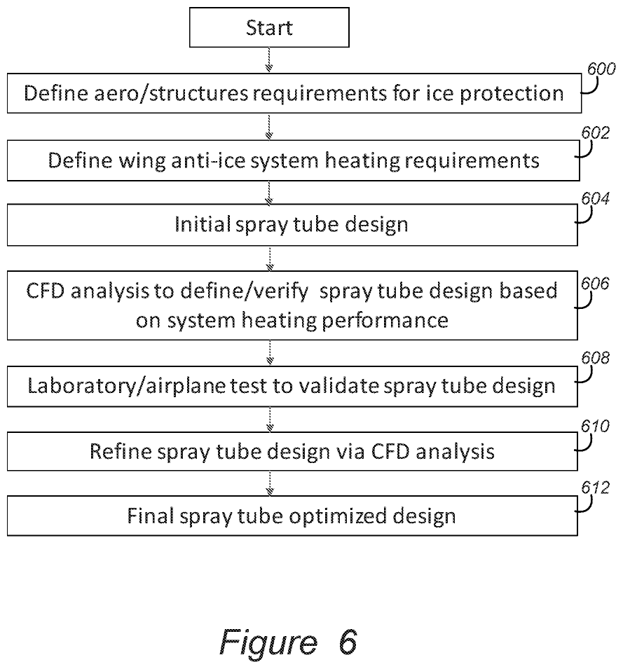

FIG. 6 illustrates a methodology for designing and optimizing the spray tube design.

The basic steps are as follows.

1. Block 600 represents defining aero/structure requirements for ice protection. For example, the step may comprise establishment of the aerodynamic requirements for how much of the wing needs to be kept clean during flight through icing conditions. The step may establish the wing leading edge or slat structural limitation such as maximum bleed temperature or bleed pressure allowed inside the slat cavity to prevent over-heat of the slat structure.

2. Block 602 represents defining the wing anti-ice system heating requirements based on the aero requirement defined in Block 600. The step may establish the cross-check of system heating requirement against the structural limitations of the area to be heated to prevent structural over-heat. Aircraft wing leading edges have different structural designs depending on the size, shape, sweep angle or other geometric factors, whether they have a moveable leading edge device such as a slat, whether the wing contains internal fuel tanks, or other factors related to the mission of the aircraft. Thermal wing anti/de-icing systems are conventionally designed with the assumption that the wing leading edge has an internal nose beam in the spanwise direction for providing structural stiffness to the leading edge cavity. Thus, conventional de-icing systems (see e.g., U.S. Pat. No. 5,011,098) utilizing a piccolo tube (302) are used in conjunction with the structural members (304) (such as a nose beam (306) or double wall) that guide the hot air sprayed from the spray tube to the locations on the wing that are used to de-ice the wing.

However, one or more wing designs may require reduced or no internal structure (e.g., no nose beam (306)) to direct the flow of hot air (408) from the spray tube (406). Illustrative embodiments described herein can be uniquely designed without the need for such structural members (304). The thermal ice protection system (400) according to embodiments described herein can be used on a wing (402) that is smaller and/or having a wing leading edge (402b) that is sharper and/or a wing (402) having less or no internal space for mounting a nose beam (306). Alternatively, the thermal ice protection system (400) according to embodiments described herein can be used on a wing (402) that is larger (and/or thicker) with more room in the internal cavity but having chordwise structural members used to provide stiffness that prevent the mounting of a nose beam (306) in the wing leading edge for weight savings. For example, the thermal ice protection system (400) described herein can be installed on the Boeing 777-9X having a wing that does not have-additional structural members (304).

3. Block 604 represents initial spray tube design. The step may comprise establishing exactly where heat needs to be applied and how much heat needs to be provided in order to keep ice (416) from forming in that area (or to remove ice once it has formed). This information is used to determine how many rows of spray holes (410) to make in the spray tube (406) and in what direction they should point to provide the most heat at the required areas.

4. Block 606 represents analysis of the initial design (typically by computer codes such as internal Computational Fluid Dynamic (CFD) analysis) to define or verify the design of the spray tube based on the system heating performance.

5. Block 608 represents laboratory or aircraft testing to validate the design of the spray tube. Testing is performed, for example, in a static lab thermal chamber, in an icing wind tunnel, or on an actual airplane including the ice protection system.

6. Block 610 represents verifying testing results agree with the analysis and refining the spray tube design, (e.g., using CFD analysis). The step may comprise modifying the design to further optimize the arrangement of spray holes (410), if needed. In one or more examples, care is taken to determine arrangement of multiple rows of spray holes (410) so the right area is heated without needing any additional internal structure and while avoiding the excessive usage of engine bleed air resources.

7. Block 612 represents the final spray tube optimized design.

b. Assembly Steps

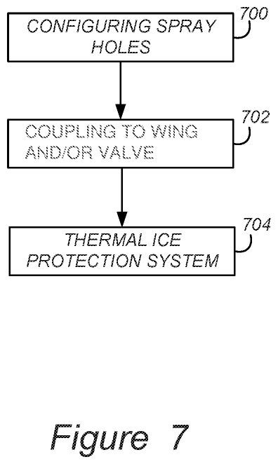

FIG. 7 is a flowchart illustrating a method of fabricating a thermal ice protection system (400).

Block 700 represents configuring the size (e.g., diameter D) and location (504) of the spray holes (410) (e.g., orifices) on a means (570) for transporting the hot air (408) along the wing (402). In various examples, means (570) comprises a tube (576) (e.g., spray tube (406)), duct, ducting, conduit, or system of tubes (576) (e.g., spray tubes (406)), conduits, ducts. Multiple sets of the spray holes (410) in the spray tube (406) or means (570) may be used to optimize the direction of the air flow from the spray holes (410).

In one or more examples, the spray holes (410) have a location (504) and orientation (510) so as to direct the hot air (408) in a direction (502) +/−90 degrees from a horizontal direction (572) or in a direction (502) that covers area from small portion of lower surface to majority of upper surface of the wing (402). In one or more further examples, the spray holes (410) are disposed 360 degrees about a circumference (574) of the spray tube (406). In various examples, the spray holes (410) have a diameter (D) in a range of 1/20 inch to ⅕ inch and are spaced apart by a distance (S) in a range of 0.5 inches to 5 inches.

The spray tube (406) may be made of a metal, composite material or metal (e.g., aluminum or titanium), or other similar material, for example.

Configuration of the spray tube may be designed using the method illustrated in FIG. 6, for example.

Block 702 represents connecting the means (570)(e.g., spray tube (406)) to a valve (422).

Block 704 represents the end result, a thermal ice protection system (400). In one or more examples, the thermal ice protection system (400) comprises a tube (576) (e.g., spray tube (406)) connected to a valve (422), the valve (422) controlling flow of engine bleed air (552) into the tube (576); and a plurality of spray holes (410) having a location (504) and orientation (510) on the tube (576) so as to direct the engine bleed air (552) towards an interior surface (404) of a wing (402) coupled to the tube (576), wherein heat (H) transported by the engine bleed air (552) melts ice (416) on an external surface (414) of the wing (402) that is thermally coupled to the interior surface (404) when the engine bleed air (552) is sprayed from the spray holes (410) onto the interior surface (404). In one or more examples, the size (e.g., diameter D3) and location of any exhaust hole (522) in the wing (402) may be optimized, e.g., the exhaust hole (522) may be smaller in embodiments without at nose beam (306).

In one or more examples, the thermal ice protection system (400) is attached to a wing (402), e.g., a wing (402) including leading edge slat (500) having the interior surface (404).

c. Example Operation

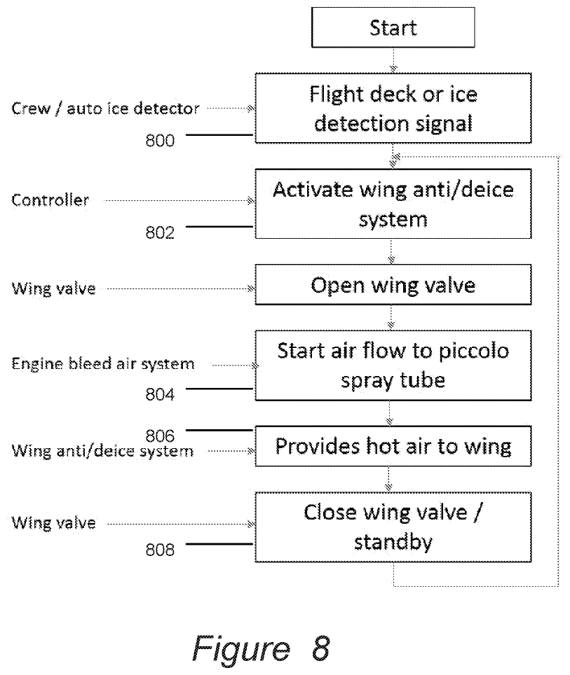

FIG. 8 is a flowchart representing operation of an exemplary thermal ice protection system (400) as described herein.

Block 800 represents, after system initialization (start), the crew or an automatic ice detector outputting a flight deck or ice detection signal indicating the presence of icing conditions where the airplane is currently flying.

Block 802 represents, in response to the ice detection signal, a controller activating the wing thermal anti/de-ice/protection system (400), comprising opening a wing valve (422) (Block 804) that starts flow of hot air (408) to the spray tube (406) from the engine bleed air system (420) (Block 806). The spray tube (406) in the thermal anti/de-ice/protection system provides (e.g., sprays) the hot air (408) towards the interior surface (404) of the wing (402) in the specified direction(s) (502) so as to melt the ice (416) on the wing (402), as represented in Block 808.

Afterwards, as represented in Block 810, the wing valve (422) closes or is set to a standby mode depending on the ice level indicated in the flight deck or ice detection signal.

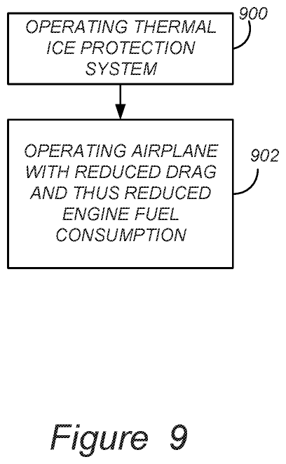

FIG. 9 is a flowchart illustrating a method of operating a turbofan engine (548) on an aircraft (532).

Block 900 represents operating a thermal ice protection system (400) connected to the turbofan engine (548) and comprising a spray tube (406) spraying engine bleed air (552) (received from the turbofan engine (548)) directly onto an interior surface (404) of the aircraft's wing (402).

Block 902 represents operating the turbofan engine (548) with reduced drag on the wing and thus reduced fuel consumption as compared to the turbofan engine (104) connected to a thermal ice protection system (300b) including a tube (302) which does not effectively (e.g., directly) spray engine bleed air (552) onto the interior surface (404) at critical locations (518) where the anti/de-icing is needed most. In addition, the thermal ice protection system (400) directly spraying the engine bleed air (552) onto the interior surface (404) reduces or prevents ice (416) build up on the wing external surface (414) more effectively, and thereby also reduces aerodynamic drag of the wing (402), as compared to the ice protection system (300b) including a tube (302) that does not directly spray engine bleed air (552) onto the interior surface (404). Conventional thermal ice protection systems (300b) that do not spray engine bleed air directly onto the interior surface (404) at critical locations where the anti/de-icing is needed most, may fail to keep the wing surface (580) free of ice (416), resulting in the additional aerodynamic drag.

Thus, the thermal ice protection system (400) is able (through careful selection of spacing and size of spray holes (410) to optimize engine bleed heat flux through the spray holes (410)) to direct the engine bleed air (552) to the interior surfaces (404) coupled to regions or external surface(s) (414) where water is more likely to impinge, thereby reducing airplane drag due to ice accretion, i.e., runback ice on the wing upper surface (536), which in turn results in saving energy and increasing fuel efficiency.

Processing Environment

Software control circuitry for the thermal ice protection system (400) could be housed in a controller (418) or processor (418b) in the thermal ice protection system (400), as illustrated in FIG. 4, or it could reside elsewhere on the aircraft in a federated controller box, module, rack, etc. The wing ice protection system logic within this controller could be manually or automatically and continuously transmitted via airplane data bus to a central computing system for indication in the flight deck as required and/or for inflight activation of the wing anti/de-ice system. Moreover, the processor (418b) coupled to or on the aircraft (532) may also control flow of the hot air (408) into the spray tube (406) without accounting for air movement along a channel or other internal structure.

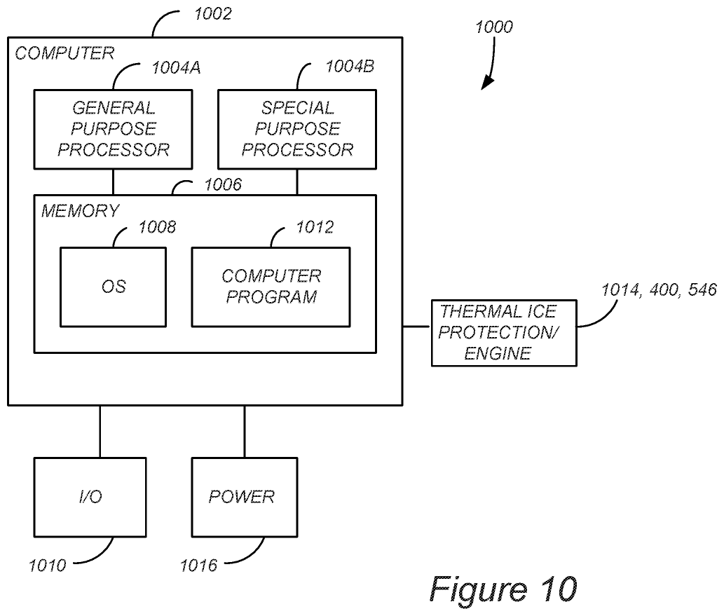

FIG. 10 illustrates an exemplary system 1000 used to implement processing elements needed to control the thermal ice protection system (400) and/or the engines (described herein.

The computer 1002 comprises a processor 1004 (general purpose processor 1004A and special purpose processor 1004B) and a memory, such as random access memory (RAM) 1006. Generally, the computer 1002 operates under control of an operating system 1008 stored in the memory 1006, and interfaces with the user/other computers to accept inputs and commands (e.g., analog or digital signals from the crew or automatic ice detector) and to present results through an input/output (I/O) module 1010. The computer program application 1012 accesses and manipulates data stored in the memory 1006 of the computer 1002. The operating system 1008 and the computer program 1012 are comprised of instructions which, when read and executed by the computer 1002, cause the computer 1002 to perform the operations herein described. In one embodiment, instructions implementing the operating system 1008 and the computer program 1012 are tangibly embodied in the memory 1006, thereby making one or more computer program products or articles of manufacture capable of reducing fuel consumption of the engine (546) in accordance with the capabilities of the thermal ice-protection systems (400) described herein. As such, the terms “article of manufacture,” “program storage device” and “computer program product” as used herein are intended to encompass a computer program accessible from any computer readable device or media.

Those skilled in the art will recognize many modifications may be made to this configuration without departing from the scope of the present disclosure. For example, those skilled in the art will recognize that any combination of the above components, or any number of different components, peripherals, and other devices, may be used.

Advantages and Improvements

Embodiments of the ice protection systems described herein provide the following advantages.

1. Illustrative thermal ice protection systems described herein save overall airplane weight (because guiding structural members such as nose beams are not required).

2. Illustrative thermal ice protection systems described herein are easier to maintain (because the spray tube is not fastened to a nose beam and therefore easily removed from the wing structure).

3. Illustrative thermal ice protection systems described herein are less expensive because they contain fewer complex parts (such as structural members).

4. Illustrative thermal ice protection systems described herein enable operation of an aircraft with increased fuel efficiency (because the system provides better performance in keeping wing surfaces free of ice and therefore reduces aerodynamic drag).

5. A thermal ice protection system as described herein can be sized and otherwise designed to provide equivalent performance for the upper and lower wing leading edge surfaces, as compared to existing systems which much be optimized for the performance on one surface at the expense of the performance on the other surface.

6. Exemplary systems described herein can be installed in areas or wings where it is not feasible to install the guiding structural members (e.g., smaller or larger wings). 7. The thermal ice protection systems described herein may be designed to access regions that were previously inaccessible without the structural members and/or access regions with more precision, thereby reducing unwanted condensation (leading to corrosion) on wing structures.

### CONCLUSION

This concludes the description of the preferred embodiments of the present disclosure. The foregoing description of the preferred embodiment has been presented for the purposes of illustration and description. It is not intended to be exhaustive or to limit the disclosure to the precise form disclosed. Many modifications and variations are possible in light of the above teaching. It is intended that the scope of rights be limited not by this detailed description, but rather by the claims appended hereto.

What is claimed is:

1. An aircraft (532), comprising:
a wing (402) including a leading edge slat (500) having an interior surface (404);
a thermal ice protection system (400) attached to the wing (402) and including a spray tube (406), the thermal ice protection system (400) connected to an engine (546) on the aircraft (532) so as to transfer hot air (408) from the engine (546) into the spray tube (406);
the spray tube (406) including a plurality of spray holes (410) through which the hot air (408) can be sprayed; and
wherein the spray tube (406) is positioned in relation to the interior surface (404) of the leading edge slat (500), and the spray holes (410) are disposed in the spray tube (406), such that the hot air (408) can be directly sprayed to a plurality of predetermined locations (412) on the interior surface (404) of the leading edge slat (500).

2. The aircraft (532) of claim 1, wherein:
heat (H) is transported by the hot air (408) sprayed from the spray holes (410); and
the interior surface (404) is thermally coupled to an external surface (414) on the wing (402) where ice (416) may form during flight, so that at least a portion of the heat (H) is transferred to the external surface (414) and melts the ice (416) or inhibits formation of the ice (416).

3. The aircraft (532) of claim 1, further comprising:
the wing (402) including a fixed, aft end (530) spaced apart from the leading edge slat (500);
the spray tube (406) disposed between the leading edge slat (500) and the fixed, aft end (530);
a plurality of supports (522a, 522b) disposed in a spaced relationship along the wing (402); and
the spray tube (406) attached to the supports (522a, 522b) such that the hot air (408) can be sprayed through the spray holes (410) at the predetermined locations (412).

4. The aircraft (532) of claim 3, wherein the spaced relationship is such that the supports (522a, 522b) are connected to the leading edge slat (500) and attach the spray tube (406) to the leading edge slat (500).

5. The aircraft (532) of claim 1, wherein the spray tube (406) is attached to the leading edge slat (500).

6. The aircraft (532) of claim 1, wherein the plurality of spray holes (410) are disposed in a plurality of rows (508a, 508b, 508c) on the spray tube (406).

7. The aircraft (532) of claim 1, wherein the spray holes (410) are located and oriented so as to direct the hot air (408) in a direction (514) +/−90 degrees from a horizontal direction (572).

8. The aircraft (532) of claim 1, wherein the spray holes (410) are disposed 360 degrees about a circumference (574) of the spray tube (406)

9. The aircraft (532) of claim 1, wherein the spray holes (410) have a diameter (D) in a range of 1/20 inch to ⅕ inch and are spaced apart by a distance in a range of 0.5 inches to 5 inches.

10. The aircraft (532) of claim 1, wherein the spray tube (406) has a diameter (D2) in a range of 1 inch to 10 inches.

11. The aircraft (532) of claim 1, wherein the spray tube (406) has a length (L) in a range of 5 feet to 80 feet.

12. The aircraft (532) of claim 1, wherein the spray tube (406) comprises a composite material or metal.

13. The aircraft (532) of claim 1, further comprising open space (520) between the spray holes (410) and the predetermined locations (412).

14. The aircraft (532) of claim 1, wherein the wing (402) does not include a wall or other structural member (304) that guides engine bleed air (552) from a tube (302) to predetermined locations (330) for melting ice (332).

15. The aircraft (532) of claim 1, further comprising a processor (524) coupled to the thermal ice protection system (400), wherein the processor (524) controls flow of the hot air (408) into the spray tube (406) without accounting for air movement along a channel or other internal structure.

16. The aircraft (532) of claim 1, wherein the aircraft (532):
has a wing span (534) in a range of 40-120 feet,
the wing (402) having a maximum thickness (T) in a range of 1-5 feet, and
an upper surface (536) and a lower surface (538) of the wing (402) have tangents (540, 542) at an angle (543) of less than 30 degrees when the tangent (540) to the upper surface (536) and the tangent (542) to the lower surface (538) of the wing are at points (544a, 544b) on the upper surface (536) and the lower surface (538) directly above and directly below the spray tube (406), respectively.

17. The aircraft (532) of claim 1, wherein the wing (402) does not include a nose beam (306).

18. A thermal ice protection system (400), comprising:
a tube (576) connected to a valve (422), the valve controlling flow of engine bleed air into the tube; and
a plurality of holes (410b) having a location (504) and orientation (510) on the tube (576) so as to direct the flow of the engine bleed air (552) towards an interior surface (404) of a wing (402) coupled to the tube (576), wherein heat (H) transported by the engine bleed air (552) melts ice (416) on an external surface (414) of the wing (402) that is thermally coupled to the interior surface (404) when the engine bleed air (552) is sprayed from the holes (410b) onto the interior surface (404).

19. A method of operating a turbofan engine, comprising:
operating a thermal ice protection system (400) connected to the turbofan engine (548) and comprising a spray tube (406) spraying engine bleed air (552), received from the turbofan engine (548), directly onto an interior surface (404) of an aircraft's wing (402); and
operating the turbofan engine (548) with reduced fuel consumption as compared to the turbofan engine (104) connected to an ice protection system (300b) including a spray tube (406) that does not directly spray the engine bleed air (552) onto the interior surface (404) at critical locations where the anti/de-icing is needed most, wherein:
the thermal ice protection system (400) directly spraying the engine bleed air (552) onto the interior surface (404) reduces or prevents ice (416) build up on the wing external surface (414) more effectively, and thereby also reducing aerodynamic drag of the wing (402), as compared to the ice protection system (300b) including a tube (302) that does not directly spray engine bleed air (552) onto the interior surface (404).

20. The method of claim 19, wherein the spray holes (410) are located and oriented so as to direct the hot air (408) in a direction (514) +/−90 degrees from a horizontal direction (516).
